(19) United States
(12) Patent Application Publication
(10) Pub. No.: US 2016/0375379 A1
(43) Pub. Date: Dec. 29, 2016

(54) SEPARATION APPARATUS, FLUID DEVICE, SEPARATION METHOD AND MIXING METHOD

(71) Applicants: The University of Tokyo, Tokyo (JP); NIKON CORPORATION, Tokyo (JP)

(72) Inventors: Takanori ICHIKI, Tokyo (JP); Ayako HAYASHI, Tokyo (JP); Masashi KOBAYASHI, Tokyo (JP); Kenji MIYAMOTO, Yokohama-shi (JP)

(21) Appl. No.: 15/260,129

(22) Filed: Sep. 8, 2016

Related U.S. Application Data
(63) Continuation of application No. PCT/JP2015/057628, filed on Mar. 16, 2015.

(30) Foreign Application Priority Data
Mar. 17, 2014 (JP) 2014-053353

(51) Int. Cl. B01D 19/00

(52) U.S. Cl. CPC B01D 19/0042; B01D 19/0063; B01D 19/0036

(57) ABSTRACT

A separation apparatus separates a substance contained in a liquid, and includes a liquid storage part having a liquid storage structure, a discharge flow path disposed at a bottom surface of the liquid storage structure and discharges the liquid stored in the liquid storage structure, a discharge flow path valve installed at the discharge flow path, and an introduction flow path that introduces the liquid into the liquid storage part.

### CROSS-REFERENCE TO RELATED APPLICATION

Priority is claimed on Japanese Patent Application No. 2014-053353, filed Mar. 17, 2014. This application is a continuation application of International Patent Application No. PCT/JP2015/057628, filed on Mar. 16, 2015. The contents of the above-mentioned applications are incorporated herein by reference.

### BACKGROUND

The present invention relates to a separation apparatus, a fluid device, a separation method and a mixing method. More specifically, the present invention relates to a separation apparatus, a fluid device, a separation method and a mixing method that are capable of separating substances contained in a liquid.

In recent years, the development or the like of micro-total analysis systems (μ-TAS) for the purpose of high speed, high efficiency and integration of tests or miniaturization of inspection instruments in the field of in vitro diagnosis has been in the spotlight, and active research is being carried out globally.

The μ-TAS is better than an inspection instrument in the related art in that measurement and analysis can be performed using a small amount of sample, portability is possible, the instruments are disposably usable at a low cost, and so on.

Further, when expensive reagents are used or a small amount of multiple specimens is tested, the μ-TAS has been attracting attention as a method having high usability.

In analysis of a specimen using the μ-TAS, mixing, separation, extraction, or the like, of substances flowing in a device may be required. For example, when bubbles are entrained in a liquid serving as an analysis target, the bubbles may cause interference in analysis, and such bubbles should be separated and removed from the liquid.

Japanese Unexamined Patent Application, First Publication No. 2006-234430 discloses an apparatus for removing bubbles from a liquid stored in the trap container, in which a liquid reservoir is built in a trap container. In addition, Japanese Unexamined Patent Application, First Publication No. 2007-3268 discloses an apparatus having a bubble trap section formed in the middle of a flow path in the device and a bubble removal means configured to remove bubbles in a fluid flowing through a main flow path.

### SUMMARY

The μ-TAS is appropriately used for measurement and analysis of a limited amount of specimen. For this reason, for example, when separation of the bubbles is performed, since the amount of liquid serving as a target from which the bubbles are separated is limited, the bubbles should be more securely separated from the liquid without waste of the liquid.

However, in the structure disclosed in Japanese Unexamined Patent Application, First Publication No. 2006-234430 and Japanese Unexamined Patent Application, First Publication No. 2007-3268, the liquid containing the bubbles may be delivered from the trap while the bubbles are not sufficiently separated from the liquid stored in the trap. In addition, in the apparatus disclosed in Japanese Unexamined Patent Application, First Publication No. 2006-234430, it is assumed that delivery of the liquid stored in the trap can be continued for a long time, and an amount of liquid sufficient for continuation of liquid delivery is stored in the trap. Accordingly, from the viewpoint that the apparatus is used for treatment of a limited amount of liquid, there is room for improvement.

The present invention is directed to provide a separation apparatus capable of more reliably separating substances, a fluid device including the separation apparatus, a separation method and a mixing method.

According to an aspect of the present invention, a separation apparatus is provided that separates a substance contained in a liquid, the separation apparatus comprising: a liquid storage part having a liquid storage structure; a discharge flow path that is disposed at a bottom surface of the liquid storage structure and that discharges the liquid stored in the liquid storage structure; a discharge flow path valve that is installed at the discharge flow path; and an introduction flow path that introduces the liquid into the liquid storage part.

According to another aspect of the present invention, a fluid device is provided that includes the above-mentioned separation apparatus.

According to another aspect of the present invention, a method of separating a gas contained in a liquid stored in a liquid storage structure comprising an introduction flow path, a discharge flow path, a gas discharge flow path, a discharge flow path valve installed at the discharge flow path, and a gas discharge flow path valve installed at the gas discharge flow path, is provided, the method includes: a liquid delivery process of delivering the liquid into the liquid storage structure from the introduction flow path in a state in which the discharge flow path valve is closed and the gas discharge flow path valve open; and a separation process of separating the gas contained in the liquid in a state in which the discharge flow path valve is closed and the gas discharge flow path valve is open.

In particular, the present invention is related to the following:

[1] A separation apparatus that separates a substance contained in a liquid, the separation apparatus comprising:

a liquid storage part having a liquid storage structure;

a discharge flow path that is disposed at a bottom surface of the liquid storage structure and that discharges the liquid stored in the liquid storage structure; and

a discharge flow path valve that is installed at the discharge flow path and that controls storage of the liquid in the liquid storage structure and discharge of the liquid stored in the liquid storage structure.

[2] The separation apparatus according to [1] above, further comprising an introduction flow path that introduces the liquid into the liquid storage part.

[3] The separation apparatus according to [1] or [2] above, wherein an inclined surface is formed at a bottom surface of the liquid storage structure.

[4] The separation apparatus according to [3] above, wherein a discharge port that discharges the liquid stored in the liquid storage structure toward the discharge flow path is formed at the bottom surface of the liquid storage structure, and the inclined surface is inclined downward toward the discharge port.

[5] The separation apparatus according to [4] above, wherein the inclined surface has a continuous gradient from side surfaces of the liquid storage structure to the discharge port.

[6] The separation apparatus according to any one of [1] to [5] above, wherein the discharge flow path has a first flow path connected to the discharge port, and a second flow path connected to the first flow path and through which a fluid flows in a direction different from the first flow path, and

the discharge flow path valve is disposed at the first flow path.

[7] The separation apparatus according to any one of [2] to [6] above, wherein a flow path inner diameter of the introduction flow path is √2 times or larger than a flow path inner diameter of the discharge flow path.

[8] The separation apparatus according to any one of [1] to [7], wherein the liquid stored in the liquid storage structure contains a gas serving as the substance, and

the liquid storage structure comprises a gas discharge port that discharges the gas from the liquid storage structure.

[9] The separation apparatus according to [8] above, comprising a gas discharge flow path connected to the gas discharge port; and

valves installed at each of the gas discharge flow path and the introduction flow path.

[10] The separation apparatus according to any one of [1] to [9] above, wherein a suction pump that introduces the liquid into the liquid storage part is connected to the gas discharge port.

[11] The separation apparatus according to any one of [3] to [10] above, wherein the discharge port formed at the bottom surface of the liquid storage structure is disposed at a central portion of the bottom surface, and the inclined surface of the liquid storage structure is inclined downward to be focused toward the discharge port.

[12] The separation apparatus according to any one of [1] to [11] above, comprising a plurality of introduction flow paths.

[13] The separation apparatus according to any one of [1] to [12] above, wherein a communication port that connects the liquid storage structure and the introduction flow path is opened at the inner wall surface of the liquid storage structure, and at least a portion of the communication port is formed above in a height direction of a liquid surface of the liquid stored in the liquid storage structure.

[14] The separation apparatus according to any one of [8] to [13] above, wherein a communication port that connects the liquid storage structure and the introduction flow path is opened at the inner wall surface of the liquid storage structure, and at least a portion of the communication port is formed below in a height direction of a liquid surface of the gas discharge port.

[15] The separation apparatus according to any one of [1] to [14] above, wherein a communication port that connects the liquid storage structure and the introduction flow path is opened at the inner wall surface of the liquid storage structure, and a portion of at least the bottom surface of the introduction flow path has an inclined section inclined with respect to and in communication with side surfaces of the liquid storage structure.

[16] The separation apparatus according to any one of [1] to [15] above, wherein an inclined member that introduces liquid into the liquid storage structure is installed to be connected to the communication port that connects the liquid storage structure and the introduction flow path, and

the inclined member protrudes toward an inside of the liquid storage structure, and is connected to the communication port such that a portion of the inclined member connected to the communication port is disposed at the uppermost side.

[17] The separation apparatus according to any one of [1] to [16] above, wherein a prevention wall that prevents liquid introduced from the introduction flow path from being scattered or flowing along the inner wall surface of the liquid storage structure is formed at an inner wall surface of the introduction flow path.

[18] The separation apparatus according to any one of [8] to [17] above, wherein the prevention wall is formed at the inner wall surface of the liquid storage structure, and

the prevention wall is formed to block a path through which the liquid introduced from the opening section of the introduction flow path can arrive at the gas discharge port.

[19] The separation apparatus according to any one of [1] to [18] above, wherein at least one surface of side surfaces or a bottom surface of the liquid storage structure has higher affinity with the liquid, which can be introduced into the liquid storage structure, than that of at least one surface of a ceiling surface of the liquid storage structure or the gas discharge flow path.

[20] A fluid device comprising the separation apparatus according to any one of [1] to [19] above

[21] A separation method of separating a substance contained in a liquid stored in a liquid storage structure using the separation apparatus according to any one of [1] to [19] above, the separation method comprising:

a liquid delivery process of delivering the liquid into the liquid storage structure; and

a separation process of dividing substances stored in the liquid storage structure by gravity and separating the substances.

[22] The separation method according to [21] above, wherein the liquid delivery process is performed in a state in which the discharge flow path valve is closed.

[23] The separation method according to [21] or [22] above, wherein the state in which the discharge flow path valve is closed is continued for a predetermined time in the separation process, and

after the separation process, a discharge process of opening the discharge flow path valve and discharging the liquid stored in the liquid storage structure is further performed.

[24] A separation method of separating a gas contained in a liquid stored in a liquid storage structure comprising an introduction flow path, a discharge flow path, a gas discharge flow path, a discharge flow path valve installed at the discharge flow path, and a gas discharge flow path valve installed at the gas discharge flow path, the separation method comprising:

a liquid delivery process of delivering the liquid into the liquid storage structure from the introduction flow path in a state in which the discharge flow path valve installed at the discharge flow path is closed and in a state in which the gas discharge flow path valve installed at the gas discharge flow path is opened; and

a separation process of separating the gas contained in the liquid in a state in which the discharge flow path valve is closed and in a state in which the gas discharge flow path valve is opened.

[25] The separation method according to [24] above, wherein the separation process comprises separating the gas contained in the liquid by suctioning the gas in the liquid storage structure via the gas discharge flow path.

[26] The separation method according to [24] or [25], comprising a discharge process of opening the discharge flow path valve in a state in which the gas discharge flow path valve is closed and discharging the liquid stored in the liquid storage structure.

[27] A method of mixing liquids in a liquid storage structure using the separation apparatus according to any one of [1] to [19] above, the mixing method comprising:

delivering a first liquid and/or a second liquid into the liquid storage structure through the introduction flow path; and

mixing the first liquid and the second liquid in the liquid storage structure.

[28] A method of mixing liquids in a liquid storage structure using the separation apparatus according to any one of [12] to [19] above, the mixing method comprising:

delivering the first liquid through one of the introduction flow paths and the second liquid through the other introduction flow path into the liquid storage structure; and

mixing the first liquid and the second liquid in the liquid storage structure.

### BRIEF DESCRIPTION OF THE DRAWINGS

FIG. 1A is a cross-sectional view schematically showing a separation apparatus of a first embodiment of the present invention.

FIG. 1B is a perspective view schematically showing the separation apparatus of the first embodiment of the present invention.

FIG. 2A is a cross-sectional view schematically showing a separation apparatus of a second embodiment of the present invention.

FIG. 2B is a cross-sectional view schematically showing the separation apparatus of the second embodiment of the present invention.

FIG. 2C is a cross-sectional view schematically showing the separation apparatus of the second embodiment of the present invention.

FIG. 3 is a cross-sectional view schematically showing a separation apparatus of a third embodiment of the present invention.

FIG. 4 is a cross-sectional view schematically showing a separation apparatus of a fourth embodiment of the present invention.

FIG. 5 is a cross-sectional view schematically showing a separation apparatus of a fifth embodiment of the present invention.

FIG. 6 is a cross-sectional view schematically showing a separation apparatus of a sixth embodiment of the present invention.

FIG. 7 is a cross-sectional view schematically showing a separation apparatus of a seventh embodiment of the present invention.

FIG. 8 is a cross-sectional view schematically showing a separation apparatus of an eighth embodiment of the present invention.

FIG. 9 is a perspective view schematically showing a fluid device of a first embodiment of the present invention.

FIG. 10 is a perspective view schematically showing a fluid device of a second embodiment of the present invention.

FIG. 11 is a view schematically showing an example of a configuration of the fluid device according to the present invention.

FIG. 12 is a view showing an example of a procedure of a separation method according to the present invention.

FIG. 13 is a view showing an example of a procedure of a mixing method according to the present invention.

FIG. 14 is a view showing an example of the procedure of the mixing method according to the present invention.

FIG. 15A is a side view showing an example of the separation apparatus of the present invention.

FIG. 15B is a perspective view showing the example of the separation apparatus of the present invention.

FIG. 16A is a side view showing the example of the separation apparatus of the present invention.

FIG. 16B is a perspective view showing the example of the separation apparatus of the present invention.

FIG. 17A is a side view showing the example of the separation apparatus of the present invention.

FIG. 17B is a top view showing the example of the separation apparatus of the present invention.

FIG. 18 is a side view showing an example of a configuration of the fluid device of the present invention.

FIG. 19A is a side view showing an example of the separation apparatus of the present invention.

FIG. 19B is a perspective view showing the example of the separation apparatus of the present invention.

FIG. 19C is a top view showing the example of the separation apparatus of the present invention.

### DESCRIPTION OF EMBODIMENTS

### Separation Apparatus

### First Embodiment

A separation apparatus of an embodiment is a separation apparatus for separating substances contained in a liquid, and includes a liquid storage part, an introduction flow path, a discharge flow path and a discharge flow path valve.

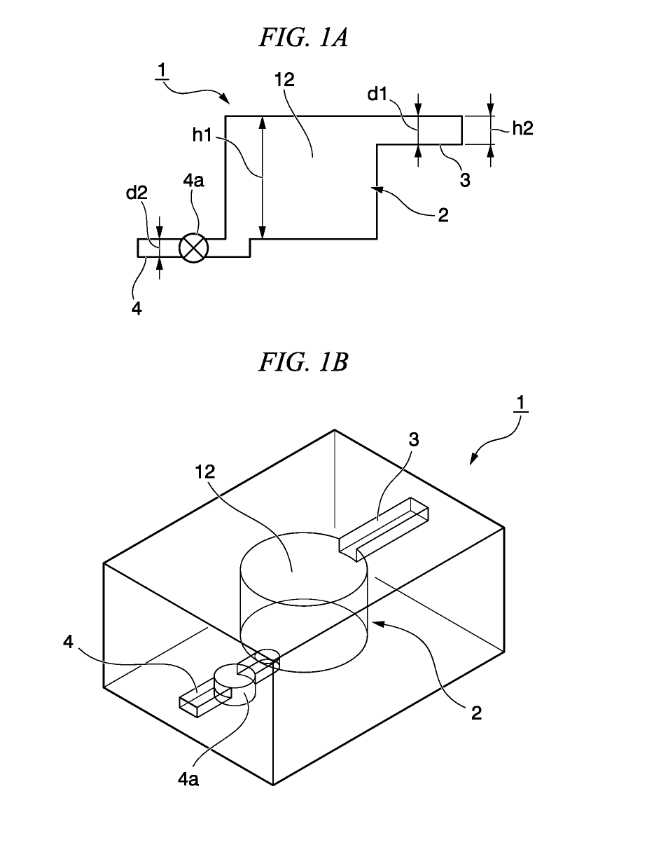

FIG. 1A is a cross-sectional view showing a separation apparatus of the embodiment. In addition, FIG. 1B is a perspective view schematically showing the separation apparatus of the embodiment. A separation apparatus 1 of the embodiment includes a liquid storage part 2 having a liquid storage structure 12, an introduction flow path 3, a discharge flow path 4 disposed at a bottom surface of the liquid storage structure 12 and configured to discharge a liquid stored in the liquid storage structure 12, and a discharge flow path valve 4a installed at the discharge flow path 4.

The liquid storage part 2 has the liquid storage structure 12. The liquid storage structure 12 is a space surrounded by a ceiling surface, side surfaces and a bottom surface serving as inner wall surfaces thereof, and has the ceiling surface and the bottom surface that are opposite to each other, and side surfaces formed to connect the ceiling surface and the bottom surface. In the liquid storage structure 12, a liquid introduced from the introduction flow path 3 can be stored in the space. As the liquid is stored in the liquid storage structure 12, and preferably, the liquid is held in the liquid storage structure 12 for a predetermined time, for example, substances stored in the liquid storage structure 12 can be divided and separated by gravity.

A height h1 of the liquid storage structure 12 may be greater than a height h2 of the introduction flow path 3. For example, the height h1 of the liquid storage structure 12 may be preferably two times or more, more preferably five times or more, and even more preferably ten times or more the height h2 of the introduction flow path 3. As an example, the height h2 of the introduction flow path 3 is 0.1 to 0.5 mm, and the height h1 of the liquid storage structure 12 is 0.2 to 5 mm. As the height h1 of the liquid storage structure 12 is greater than the height h2 of the introduction flow path 3, substances separated above and below can be efficiently collected or removed.

In the liquid storage structure 12, for example, substances having different specific weights are stored in the liquid storage structure 12, the substances are divided above and below in the liquid storage structure 12, and thus, the substances can be separated. Combinations of a liquid and a gas may be exemplified as an example of combinations of substances having different specific weights.

For example, the liquid that can be stored in the liquid storage structure may contain a gas. The liquid delivered into a flow path of a μ-TAS is mixed with air present in the μ-TAS during the liquid delivery, and the liquid may contain air. As the liquid containing the air is stored in the liquid storage structure 12 and the liquid in the liquid storage structure 12 is held for a predetermined time, the air is divided above in the liquid storage structure 12, the liquid is divided below, and thus, the air can be separated from the liquid.

As combinations of substances stored and divided in the liquid storage structure 12, in addition to combinations of a liquid and a gas, combinations of a liquid and a liquid, combinations of a liquid and a solid, combinations of a solid and a solid, or the like, may be exemplified. As division of a liquid and a liquid, division of liquids having different specific weights such as water and oil may be exemplified. As separation of a liquid and a solid, for example, division of particles (solids) dispersed in the liquid may be exemplified.

The liquid stored in the liquid storage structure 12 can be discharged from the liquid storage structure 12 through the discharge flow path 4 disposed at a bottom surface of the liquid storage structure 12. As the discharge flow path valve 4a is installed at the discharge flow path 4 and opening/closing of the discharge flow path valve 4a is controlled, storage of the liquid in the liquid storage structure 12 and discharge of the liquid stored in the liquid storage structure 12 can be controlled. By installing the discharge flow path valve 4a, a state in which the discharge flow path valve 4a is closed is continued until the substances in the liquid storage structure are sufficiently separated, and the liquid is stored in the liquid storage structure 12.

For example, until the air is sufficiently separated from the liquid stored in the liquid storage structure 12, the discharge flow path valve 4a is closed and then the discharge flow path valve 4a is opened, and thus, the liquid stored below is discharged from the liquid storage structure 12 through the discharge flow path 4. As the discharge flow path valve 4a is installed at the discharge flow path 4, only the liquid from which the air is sufficiently removed can be easily obtained. Further, as the discharge flow path valve 4a is installed at the discharge flow path 4, since the liquid can remain only in the liquid storage structure 12, the probability of wastefully discharging the liquid can be avoided. This is particularly effective because the limited amount of liquid should be treated with as little liquid waste as possible.

Facilitating the introduction of liquid into the liquid storage part 2 can also be implemented by discharging the substances in the liquid storage structure 12 from the discharge flow path 4.

Inner diameters of the introduction flow path and the discharge flow path are not particularly limited. However, from the viewpoint that the time taken for introduction of the liquid into the liquid storage structure 12 is shorter than that taken for discharge of the liquid from the liquid storage structure 12, the introduction flow path 3 may have a flow path cross-sectional area larger than that of the discharge flow path 4. When a flow path cross section is substantially circular, for example, a flow path inner diameter d1 of the introduction flow path 3 is preferably √2 times or more a flow path inner diameter d2 of the discharge flow path 4, and the flow path inner diameter d1 of the introduction flow path 3 in the vicinity of the liquid storage structure 12 is more preferably √5 times or more the flow path inner diameter d2 of the discharge flow path 4 in the vicinity of the liquid storage structure 12. In addition, for example, when d1 is √10 times d2, even when the discharge flow path valve 4a is not closed, the liquid is likely to remain in the liquid storage structure, and the probability of wastefully discharging the liquid from the liquid storage structure 12 is reduced.

An introduction point of introducing the liquid into the liquid storage structure is not particularly limited. However, when a communication port configured to connect the liquid storage structure and the introduction flow path is opened at an inner wall of the liquid storage structure, at least a portion of the communication port configured to connect the liquid storage structure and the introduction flow path may be installed above a liquid surface of the liquid stored in the liquid storage structure in a height direction.

For example, in the case in which a liquid containing air is introduced into the liquid storage structure and a liquid and air are separated in the liquid storage structure, when the communication port is disposed under the liquid surface of the liquid stored in the liquid storage structure, the liquid introduced into the liquid storage structure is directly introduced into the liquid already stored in the liquid storage structure. Then, since the liquid introduced into the liquid storage structure has had no chance to be separated from air before coming in contact with the liquid already stored in the liquid storage structure, separation efficiency of a liquid and air may be decreased. Accordingly, as at least a portion of the communication port is installed above the liquid surface of the liquid stored in the liquid storage structure in the height direction, the separation can be more efficiently performed.

A space capacity of the space in the liquid storage structure obtained by storing the liquid may be larger than a capacity of the liquid stored in the liquid storage structure. For example, the space capacity is preferably 1.5 times or more the liquid capacity, as an example, more preferably 3 times or more, and even more preferably 5 times or more. As the structure in which the space capacity is larger than the liquid capacity is provided, the substances can be more efficiently separated. In addition, as described below, even when a plurality of liquids are mixed in the liquid storage structure, as the space capacity is larger than the liquid capacity, the substances can be more efficiently mixed.

In the liquid storage structure, the space for storing the liquid has a wall surface and a bottom surface with an area in which a cross-sectional area of the introduction flow path and a cross-sectional area of the discharge port are sufficiently accommodated, and the space capacity of the space for storing the liquid is determined depending on the cross-sectional area of the introduction flow path and the cross-sectional area of the discharge port. For example, as a guide, 1 μL to 10 mL can be exemplified. As an example, when the introduction flow path has a rectangular shape with a flow path width of 100 μm and a depth of 100 μm and the discharge port has a rectangular shape with a length of 50 μm×a width of 50 μm, the space capacity of the space for storing the liquid is designed to be about 5 μL.

### Second Embodiment

A separation apparatus of the embodiment has an inclined surface formed at the bottom surface of the liquid storage structure that composes the separation apparatus of the above-mentioned first embodiment.

The separation apparatus of the embodiment has the inclined surface formed at the bottom surface of the liquid storage structure that composes the separation apparatus of the above-mentioned first embodiment, and a discharge port configured to discharge the liquid stored in the liquid storage structure toward the discharge flow path, and the inclined surface may be inclined downward toward the discharge port.

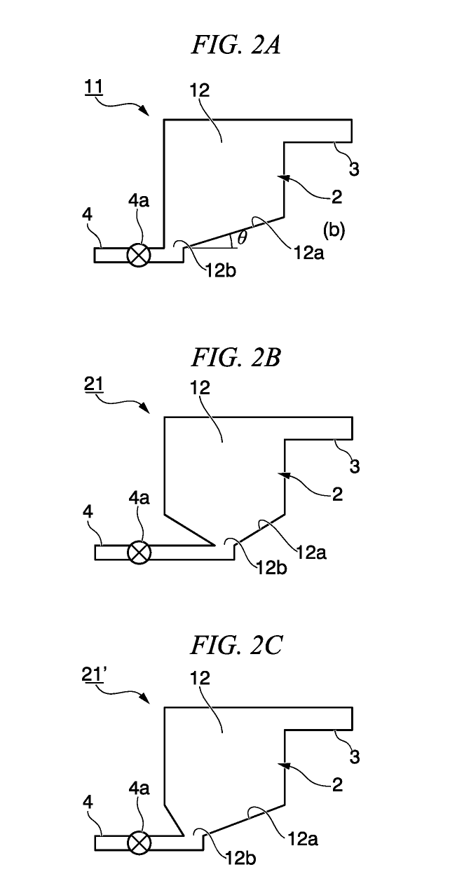

An inclined surface 12a and a discharge port 12b are formed at the bottom surface of the liquid storage structure 12 of the separation apparatus 11 of the second embodiment shown in FIG. 2A. The inclined surface 12a is formed at the bottom surface of the liquid storage structure 12, and thus, positions at which the substances stored at a lower side of the liquid storage structure are stored can be controlled. As the inclined surface 12a is inclined downward toward the discharge port 12b, the substances stored at the lower side of the liquid storage structure 12 can be efficiently sent to the discharge port 12b. Accordingly, the substances stored at the lower side of the liquid storage structure 12 can be efficiently discharged from the liquid storage structure 12 through the discharge flow path 4. In particular, as the inclined surface has a continuous gradient from the side surfaces to the discharge port, a residual liquid upon discharge when the liquid amount is small can be reduced. A circumferential edge of the discharge port in the bottom surface may be formed at a surface different from the inclined surface.

An inclination angle of the inclined surface 12a is not particularly limited. However, in one example, an inclination angle θ shown in FIG. 2A is set to 15 to 60°. For example, when the inclination angle θ is 15° or more, preferably, the liquid can be rapidly moved to the discharge port 12b and the liquid can be efficiently discharged. In addition, for example, when the inclination angle θ is 60° or less, it is preferable because separation of the substances from the liquid is facilitated even when the liquid flows along the inclined surface.

The discharge flow path 4 may have a first flow path connected to the discharge port 12b, and a second flow path connected to the first flow path and through which a fluid flows in a direction different from that of the first flow path. In addition, the discharge flow path valve 4a may be disposed at the first flow path.

When the discharge flow path has at least two flow paths in different liquid delivery directions, as the discharge flow path valve 4a is disposed in the vicinity of the discharge port 12b, the liquid can be easily stored in the liquid storage structure.

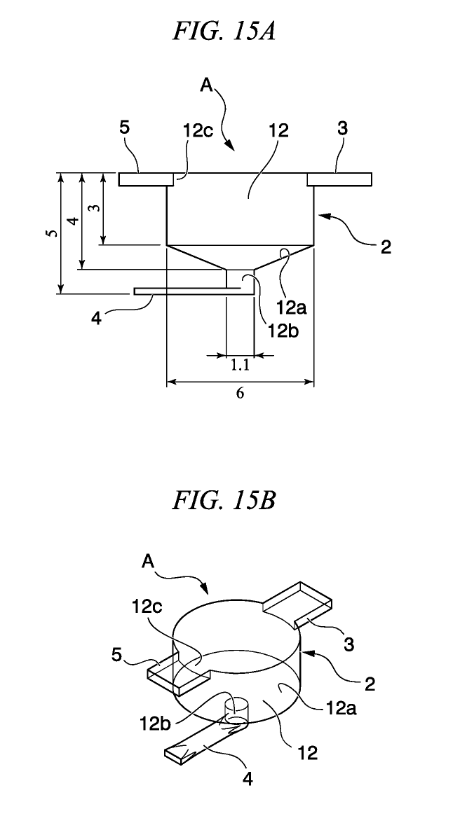

The discharge flow path 4 having at least two flow paths in different liquid delivery directions is composed by, for example, a first flow path and a second flow path that have different directions in which fluids flow, the first flow path is formed parallel to a vertical direction, and the second flow path may be exemplified as a discharge flow path formed in a direction perpendicular to the first flow path (see FIGS. 15A to 19C in the following examples). In this case, since the first flow path is formed at the lower side of the liquid storage structure and the discharge flow path valve 4a is disposed above the first flow path, while the liquid passing through the liquid storage structure flows into the space between the discharge flow path valve 4a and the discharge port 12b by gravity, separation of the substances can be easily advanced because the first flow path is formed parallel to the vertical direction, and the liquid storage structure may be used as a space for storing the liquid in the space of the first flow path.

In the present embodiment, the separation apparatus may have an inclined surface and a discharge port formed at the bottom surface of the liquid storage structure that composes the separation apparatus of the above-mentioned first embodiment, a discharge port formed at the bottom surface of the liquid storage structure may be disposed at a central section of the bottom surface, and the inclined surface of the liquid storage structure may be inclined downward to be focused toward the discharge port. The structure including the inclined surface may be a funnel shape, a mortar shape, a conical shape, a polygonal cone shape, or the like. In a separation apparatus 21 of the second embodiment shown in FIG. 2B, the discharge port 12b is disposed at the central section of the bottom surface of the liquid storage structure 12, and the inclined surface 12a may be inclined downward to be focused toward the discharge port 12b. As the discharge port 12b is disposed at the central section of the bottom surface of the liquid storage structure 12, the liquid introduced into the liquid storage structure 12 is directed toward the discharge port while being agitated, and separation of the gas from the liquid is facilitated upon agitation. In addition, as described below, even when the plurality of liquids is mixed in the liquid storage structure, mixing of the liquids by agitation easily occurs.

Further, a position of the discharge port formed at the inclined surface may deviate from a center (or a center of gravity) of a circle. In this case, an inclination angle of the inclined surface toward the discharge port may be different at a side surface side at which the introduction port is disposed and a side surface side opposite to the side surface at which the introduction port is disposed. For example, like a separation apparatus 21′ (see FIG. 2C), when the discharge port is shifted closer to the side surface side opposite to the side surface at which the introduction port is disposed than the central section of the bottom surface, the inclination angle of the side surface opposite to the side surface at which the introduction port is disposed is steeper than the inclination angle of the inclined surface of the side surface side at which the introduction port is disposed.

### Third Embodiment

In a separation apparatus of the present embodiment, the liquid storage structure that composes the separation apparatus of the above-mentioned second embodiment further includes a gas discharge port configured to discharge a gas from the liquid storage structure.

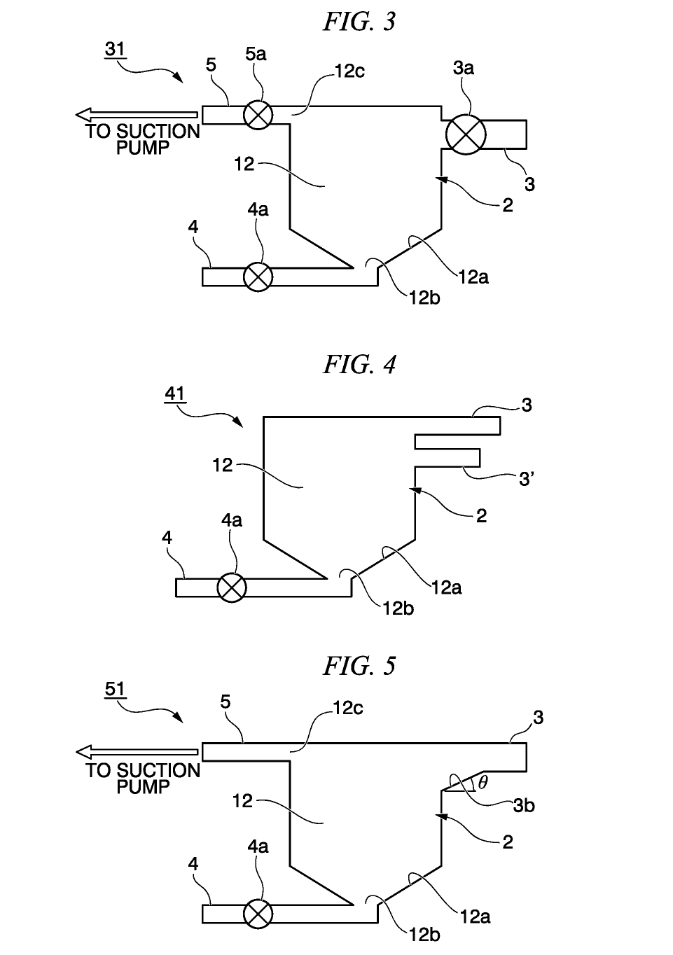

FIG. 3 is a cross-sectional view showing a separation apparatus 31 of the present embodiment. The liquid storage structure 12 that composes the separation apparatus 31 includes a gas discharge port 12c configured to discharge a gas from the liquid storage structure 12. When the liquid is introduced into the liquid storage part 2 from the introduction flow path 3 and the gas entrained in the liquid enters the liquid storage structure, an atmospheric pressure in the container is increased. For this reason, when a distal end of a gas discharge flow path connected to the gas discharge port 12c is exposed to the atmosphere, the gas present in the liquid storage structure can be naturally discharged from the gas discharge port 12c without an operation such as suction or the like, and the liquid can be more smoothly introduced into the liquid storage part 2. In addition, the gas separated and discharged in the liquid storage structure 12 can be discharged from the gas discharge port 12c. For this reason, the amount of the liquid stored in the liquid storage structure can also be increased.

When the communication port configured to connect the liquid storage structure and the introduction flow path is opened at the inner wall surface of the liquid storage structure, as shown in FIG. 3, at least a portion of the communication port configured to connect the liquid storage structure and the introduction flow path is preferably installed below the gas discharge port in the height direction.

In addition, the lowermost section of the introduction flow path is preferably formed below the uppermost section of the ceiling surface of the liquid storage structure in the height direction. For example, the lowermost section of the introduction flow path is preferably installed 0.5 mm or more below the uppermost section of the ceiling surface of the liquid storage structure in the height direction, more preferably 1 mm or more below, and even more preferably 2 mm or more below.

Furthermore, the gas discharge port is preferably installed above the liquid surface of the liquid stored in the liquid storage structure in the height direction. This is, to prevent the liquid introduced from the introduction flow path 3 from being discharged from the gas discharge port. For example, in consideration of a meniscus of the liquid surface, the gas discharge port is preferably formed 0.5 mm or more above the liquid surface of the liquid stored in the liquid storage structure in the height direction, more preferably 1 mm or more above, and even more preferably 1.5 mm or more above.

The liquid introduced into the liquid storage structure cannot easily reach the gas discharge port 12c according to provisos related to the positions of the communication port and the gas discharge port. For this reason, the probability of wastefully discharging the liquid can be avoided.

The separation apparatus of the present embodiment includes the gas discharge flow path connected to the gas discharge port, and may include valves installed at each of the gas discharge flow path and the introduction flow path. The separation apparatus 31 includes a gas discharge flow path valve 5a formed at a gas discharge flow path 5, and an introduction flow path valve 3a installed at the introduction flow path 3. By providing the gas discharge flow path valve 5a, a gas discharge amount, gas discharge timing from the liquid storage structure 12, or the like, can be easily controlled. By providing the introduction flow path valve 3a, an introduction amount of the liquid, introduction timing of the liquid into the liquid storage structure 12, or the like, can be easily controlled. Even when the liquid amount that can be introduced into the liquid storage structure is large compared to a capacity in the liquid storage structure, the introduction flow path valve 3a is closed, and cutoff of the liquid extent introduced into the liquid storage structure becomes possible. As introduction, separation and discharge of the liquid into/from the liquid storage structure are repeated, a continuous fluid in which a gas has been removed from the liquid can be produced.

The separation apparatus of the present embodiment may further include a suction pump configured to introduce a liquid into the liquid storage part. When the liquid is introduced into the liquid storage part, the suction pump (not shown) may be connected such that suction is performed via the gas discharge port 12c. As the gas in the liquid storage structure 12 is suctioned from the gas discharge port 12c, introduction of the liquid into the liquid storage part 2 can be facilitated while avoiding unintended discharge of the substances stored in the liquid storage structure.

### Fourth Embodiment

A separation apparatus of the present embodiment includes a plurality of introduction flow paths installed at the separation apparatus of the above-mentioned second embodiment. A separation apparatus 41 of the embodiment shown in FIG. 4 includes a first introduction flow path 3 and a second introduction flow path 3′ that are configured to introduce a liquid into the liquid storage part 2. The separation apparatus including the plurality of introduction flow paths may be applied to the case in which a plurality of types of liquids is introduced into the liquid storage part. When a plurality of substances is introduced into the liquid storage structure, both mixing and separation of the substances stored in the liquid storage structure can be performed in the liquid storage part.

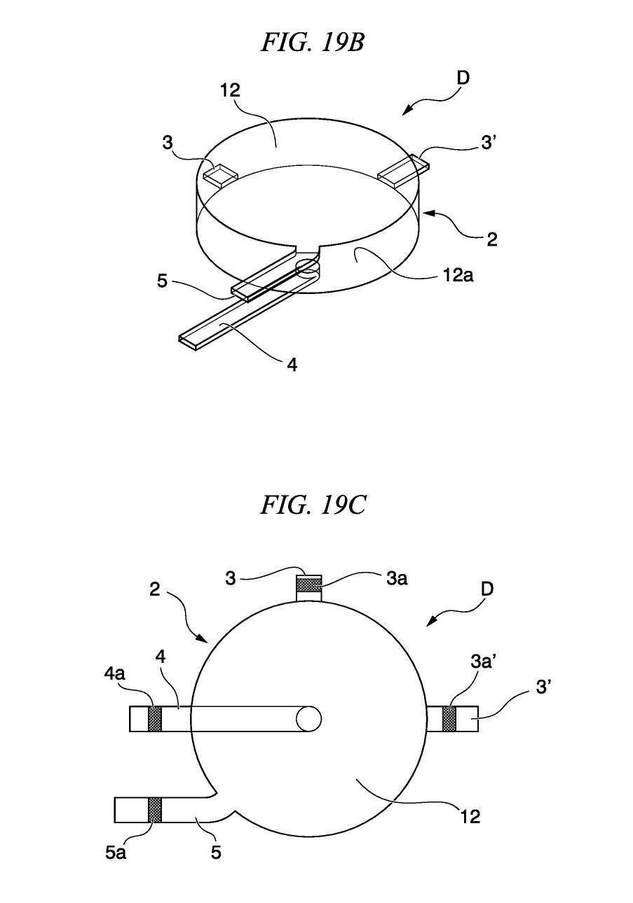

A positional relationship of the introduction flow paths is not particularly limited. However, when the introduction flow paths are radially disposed like the separation apparatus shown in the following Example 2 (see FIGS. 19A to 19C), the liquid can be efficiently mixed as an agitation effect occurs.

Additionally, a Y-shaped flow path is exemplified as another structure used to mix a plurality of known liquids. When two liquids are joined in the Y-shaped flow path, the two liquids can be gradually mixed due to non-uniform distribution of a flow velocity caused by diffusion during liquid delivery or resistance in the flow path. However, when the Y-shaped flow path is used, since the time taken to achieve mixing is increased and a flow path length is also increased, the Y-shaped flow path is not suitable for speedup or miniaturization of the device.

On the other hand, when mixing of the two liquids is performed using the liquid storage part according to the present invention, since mixing efficiency of the liquids is good, the liquids can be mixed without using means configured to facilitate the mixing. As means configured to facilitate the mixing, for example, a mechanism of mixing the liquids by applying vibrations from the outside, repeating suction and compression, or the like, are exemplified. However, addition of such a mechanism causes a control system to become complicated and interferes with miniaturization. When the liquids are mixed using the liquid storage part, for example, the liquids can be mixed by only a suction operation of introducing the liquids into the liquid storage part. When the liquid storage part is used, mixing of the liquids can be performed in a small space with a short time.

### Fifth Embodiment

A separation apparatus of the present embodiment is distinguished from the separation apparatus of the third embodiment in that a communication port configured to connect the liquid storage structure and the introduction flow path is opened at the inner wall surface of the liquid storage structure and an inclined section in which a portion of at least the bottom surface of the introduction flow path is inclined with respect to and comes in communication with the side surface of the liquid storage structure is formed. The inclined section is preferably formed in the vicinity of the communication port. FIG. 5 shows a cross-sectional view showing a separation apparatus 51 of the present embodiment. When the liquid is introduced into the liquid storage structure 12 through the introduction flow path 3, the introduced liquid flows along the inner wall surface of the liquid storage structure 12 to reach the gas discharge port 12c, and the liquid may be discharged. The separation apparatus 51 of the present embodiment has an inclined section 3b formed at a position of at least the bottom surface of the introduction flow path 3. The liquid flowing through the introduction flow path 3 flows along the bottom surface of the inclined section 3b to be introduced into the liquid storage structure 12. For this reason, the introduction position of the liquid can be disposed at a suitable distance from the ceiling surface, and the liquid can be prevented from flowing along the liquid storage structure inner wall to reach the gas discharge port 12c. For this reason, the probability of wastefully discharging the liquid can be avoided.

In addition, when the liquid is introduced along the inclined section 3b, in comparison with the case in which the inclined section 3b is not provided, a contact chance of the liquid with an air layer are increased. For this reason, separation of bubbles contained in the liquid can be facilitated using the surface tension of the liquid by installing the inclined section 3b. An inclination angle of the inclined section 3b may be equal to or different from that of the inclined surface 12a.

### Sixth Embodiment

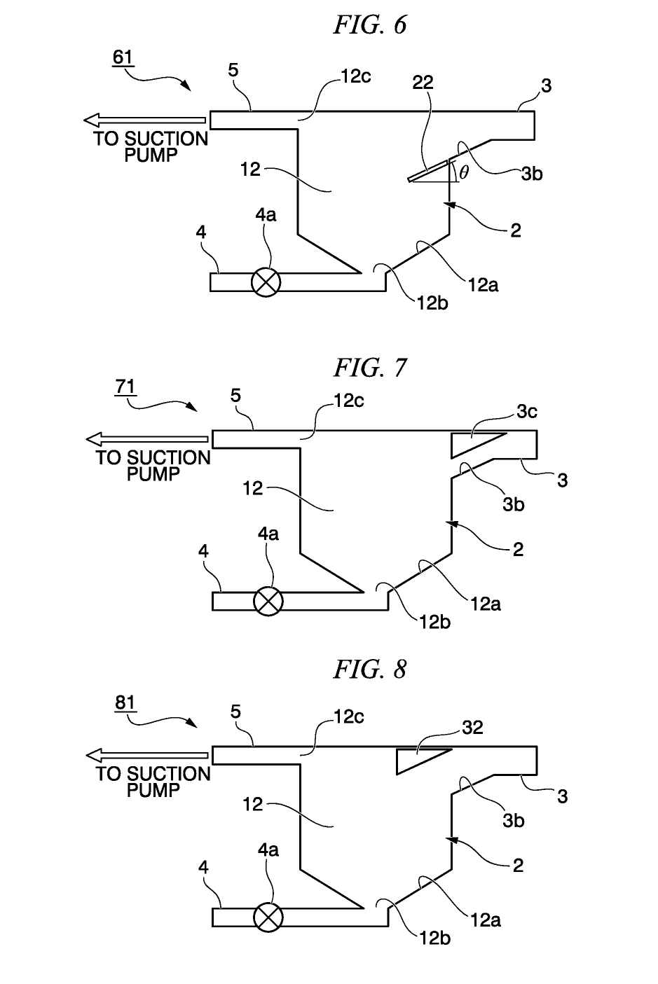

As the inclined section for introduction of the liquid into the liquid storage structure, a separation apparatus may be in a state in which an inclined member configured to introduce a liquid into the liquid storage structure is formed to be connected to a communication port configured to connect the liquid storage structure and the introduction flow path, the inclined member protrudes toward the inside of the liquid storage structure, and a portion of the inclined member connected to the communication port configured to connect the liquid storage structure and the introduction flow path is connected to be disposed uppermost. FIG. 6 shows a cross-sectional view showing a separation apparatus 61 of the embodiment. By forming an inclined member 22, the liquid flowing through the introduction flow path 3 is introduced into the liquid storage structure 12 along the inclined member 22. For this reason, the introduction position of the liquid can be disposed at a suitable distance from the ceiling surface, and the liquid can be prevented from flowing along the liquid storage structure inner wall to reach the gas discharge port 12c. For this reason, the probability of wastefully discharging the liquid can be avoided. An inclination angle of the inclined member 22 may be equal to or different from the inclined section 3b.

### Seventh Embodiment

FIG. 7 is a cross-sectional view showing a separation apparatus of the embodiment. A separation apparatus 71 of the present embodiment is distinguished from the separation apparatus of the above-mentioned fifth embodiment in that a prevention wall 3c configured to prevent the liquid introduced from the introduction flow path 3 from being scattered or flowing along the inner wall surface of the liquid storage structure is formed at the inner wall surface of the introduction flow path 3. For example, the prevention wall 3c is formed at the ceiling surface of the introduction flow path 3. As described in the above-mentioned fifth embodiment and sixth embodiment, the liquid introduced from the introduction flow path 3 may flow along the inner wall surface of the liquid storage structure 12 to arrive at the gas discharge port 12c. In particular, when the liquid is suctioned by a strong suction pressure, or the like, the liquid further introduced from the introduction flow path 3 easily flows along the inner wall surface of the liquid storage structure 12 to arrive at the gas discharge port 12c. In addition, when the liquid is suctioned by a strong suction pressure, or the like, the liquid introduced from the introduction flow path 3 may be scattered in the liquid storage structure 12 and may arrive at the gas discharge port 12c. In the separation apparatus 71 of the present embodiment, as the prevention wall 3c formed at the ceiling surface of the introduction flow path 3 is provided, the liquid flowing through the introduction flow path 3 can be prevented from flowing along the inner wall surface of the liquid storage structure 12 to arrive at the gas discharge port. In addition, the prevention wall 3c can prevent the liquid introduced from the introduction flow path 3 from being scattered in the liquid storage structure 12 to arrive at the gas discharge port 12c. For this reason, the probability of wastefully discharging the liquid can be avoided.

### Eighth Embodiment

A structure corresponding to the prevention wall may be formed in the liquid storage structure 12. That is, in a separation apparatus, a prevention wall configured to prevent the liquid introduced from the introduction flow path from being scattered or flowing along the inner wall surface of the liquid storage structure may be formed at the inner wall surface of the liquid storage structure, and the prevention wall may be formed to block a path through which the liquid introduced from the opening section of the introduction flow path arrives at the gas discharge port.

For example, the prevention wall is formed at the ceiling surface of the liquid storage structure. FIG. 8 is a schematic cross-sectional view showing the separation apparatus of the present embodiment. A separation apparatus 81 of the present embodiment is distinguished from the separation apparatus of the above-mentioned fifth embodiment in that a prevention wall 32 is formed at the ceiling surface of the liquid storage structure 12, and the prevention wall 32 is formed to block a path through which the liquid introduced from the opening section of the introduction flow path 3 arrives at the gas discharge port 12c. Like the prevention wall 3c described in the above-mentioned seventh embodiment, the prevention wall 32 can prevent the liquid flowing through the introduction flow path 3 from flowing along the inner wall surface of the liquid storage structure 12 to arrive at the gas discharge port or the liquid introduced from the introduction flow path 3 from being scattered in the liquid storage structure 12 to arrive at the gas discharge port 12c. For this reason, the probability of wastefully discharging the liquid can be avoided.

A material of the separation apparatus is not particularly limited but, for example, may be a resin, an elastomer, a metal, ceramics, glass, or the like. The material of the separation apparatus is not particularly limited. However, the material of the separation apparatus is preferably a material having low gas transmissivity. In addition, the material itself preferably contains no gas. This is because, when the inside of the container has a low pressure, a gas may be generated from the container wall surface to be melted in the liquid stored in the container. In addition, when the gas is discharged while the liquid is stored in the liquid storage structure, a material having a low water absorption rate is desirably selected. A material having a high water absorption rate has a possibility of absorbing water from the liquid when the liquid falls, discharging the contained water when the inside of the liquid storage structure reaches a low pressure, and leading to unintended mixing of the liquid.

From the viewpoint that the liquid is efficiently stored at a lower portion of the liquid storage structure space and bubbles are efficiently removed, the side surfaces and/or the bottom surface of the liquid storage structure may have high affinity with the liquid that can be introduced into the liquid storage structure. In addition, from the same viewpoint, the ceiling surface and/or the gas discharge flow path of the liquid storage structure may have low affinity with the liquid that can be introduced into the liquid storage structure. That is, the affinity with the side surfaces and/or the bottom surface of the liquid storage structure with respect to the liquid that can be introduced into the liquid storage structure may be larger than the affinity with the ceiling surface and/or the gas discharge flow path of the liquid storage structure with respect to the liquid.

For example, when an aqueous solution is introduced into the liquid storage structure, the side surfaces and/or the bottom surface of the liquid storage structure preferably have hydrophilicity. Similarly, for example, when the aqueous solution is introduced into the liquid storage structure, the ceiling surface and/or the gas discharge flow path of the liquid storage structure are preferable to have hydrophobicity. For example, as the side surfaces and/or the bottom surface of the liquid storage structure have hydrophilicity, since the affinity with the liquid introduced into the liquid storage structure is increased, bubbles can be efficiently separated from the liquid. In addition, as the ceiling surface and/or the gas discharge flow path of the liquid storage structure have hydrophobicity, the liquid can be prevented from flowing along the ceiling surface to arrive at the gas discharge flow path.

### Fluid Device

### First Embodiment

A fluid device of the present embodiment is a fluid device including the separation apparatus of the above-mentioned fifth embodiment. Further, a flow path that composes the fluid device of the present embodiment may be of a micrometer scale or may be a millimeter scale. In either case, the fluid device may be referred to as “a micro fluid device”, meaning a device having fine flow paths.

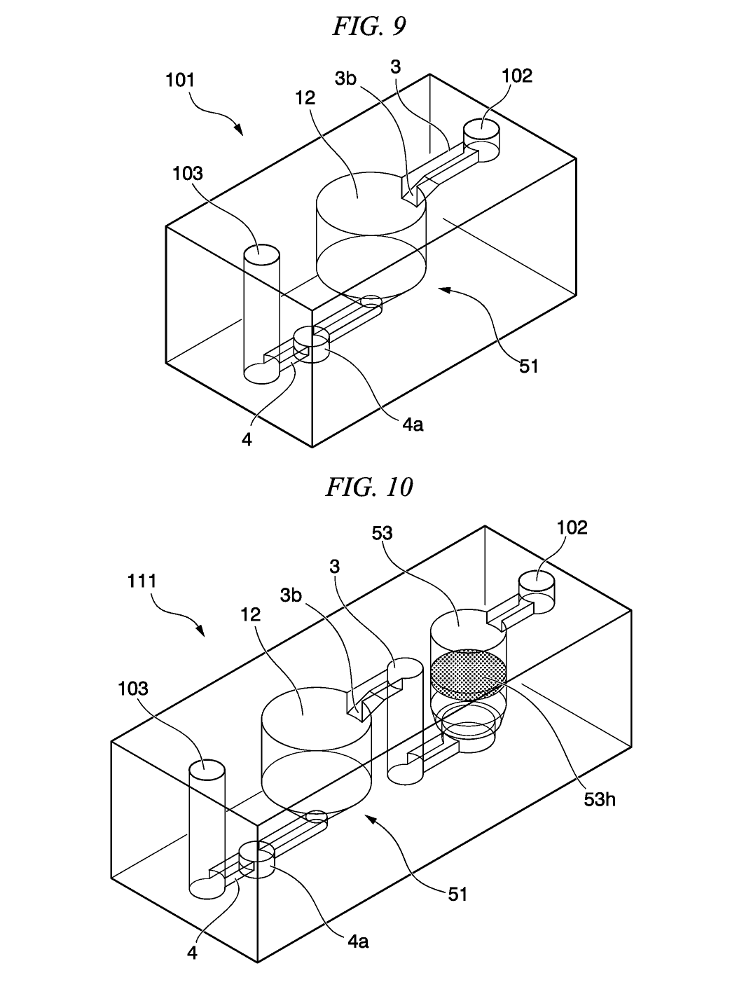

FIG. 9 is a schematic diagram showing a basic configuration of the fluid device of the present embodiment. A fluid device 101 of the present embodiment includes the separation apparatus 51, an inlet 102 and an outlet 103 that are installed at a substrate. The outlet 103 also has a function as a connector to a suction pump or the like when delivery of suctioned liquid is performed, and also has a function of extracting air such as a vent filter or the like when delivery of pushed liquid from the inlet 102 is performed or when a driving force is present in the fluid device.

### Second Embodiment

A fluid device of the present embodiment further includes a biological molecule-refining unit installed at the fluid device of the above-mentioned first embodiment. FIG. 10 shows a basic configuration of the fluid device of the present embodiment. A fluid device 111 has the separation apparatus 51 downstream from a biological molecule-refining unit 53, and the liquid obtained in the biological molecule-refining unit 53 is delivered to the separation apparatus 51.

The biological molecule-refining unit may have a porous structure. As the unit having the porous structure, for example, a silica membrane 53h generally used as a nucleic acid refining technology may be exemplified. Air can easily entrain the liquid passing through the porous structure.

In addition, when precise quantification of biological molecules is to be performed in biological substance detection application that is continuously performed, or the like, eluate containing biological molecules may be required to be completely collected from the biological molecule-refining unit 53 as much as possible. However, for this reason, when the liquid is collected by a strong suction force from the biological molecule-refining unit 53, some of the liquid is eluted from the biological molecule-refining unit 53 in a state in which some of the liquid contains sprays or bubbles. In this point, in the fluid device 111 of the present embodiment, as the biological molecule-refining unit 53 and the separation apparatus 51 are combined and used, bubbles can be easily separated from the eluate containing the biological molecule obtained and refined in the biological molecule-refining unit 53.

In addition, the fluid device may be a fluid device configured to detect biological molecules contained in exosomes in a specimen. As such a fluid device, for example, a fluid device including the separation apparatus of the above-mentioned fifth embodiment, an exosome-refining unit having a layer modified with a compound having hydrophobic chains and hydrophilic chains, and a biological molecule detection unit can be used.

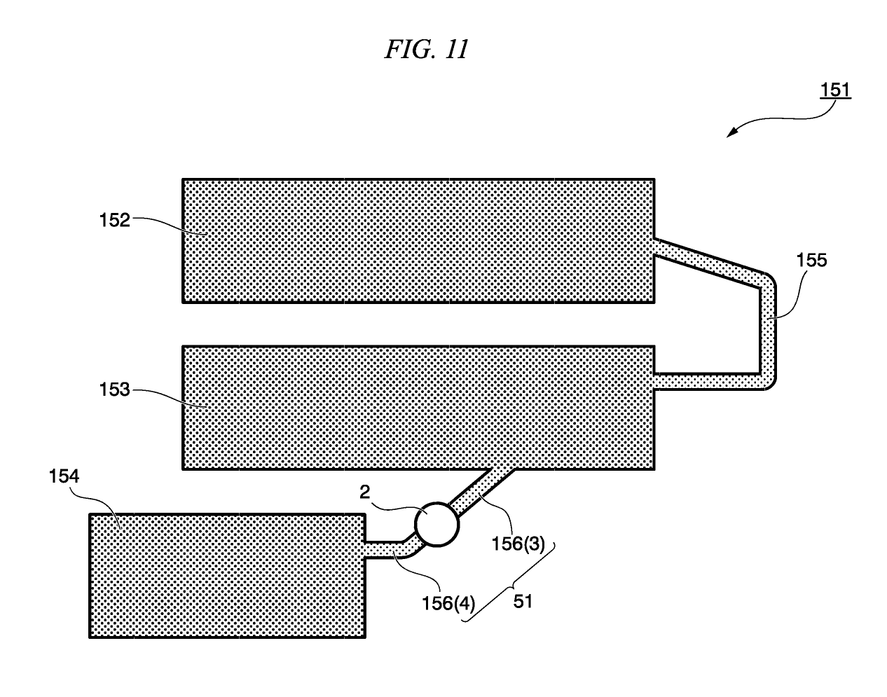

As an example of the fluid device, a fluid device 151 shown in FIG. 11 is exemplified. The fluid device 151 is a fluid device configured to detect biological molecules contained in exosome of a specimen, and includes an exosome-refining unit 152 having a layer modified with a compound having hydrophobic chains and hydrophilic chains, a biological molecule-refining unit 153, a biological molecule detection unit 154, a first flow path 155 configured to connect the exosome-refining unit 152 and the biological molecule-refining unit 153, a second flow path 156 configured to connect the biological molecule-refining unit 153 and the biological molecule detection unit 154, and valves of a first aspect disposed at desired places of the flow paths. The entirety or a part of the second flow path 156 may be the introduction flow path 3 and the discharge flow path 4 of the separation apparatus 51.

### <<Separation Method>>

A separation method of the present embodiment is a method of separating substances contained in a liquid stored in a liquid storage structure using the above-mentioned separation apparatus, and has a liquid delivery process of delivering the liquid into the liquid storage structure, and a separation process of dividing the substances stored in the liquid storage structure by gravity and separating the substances.

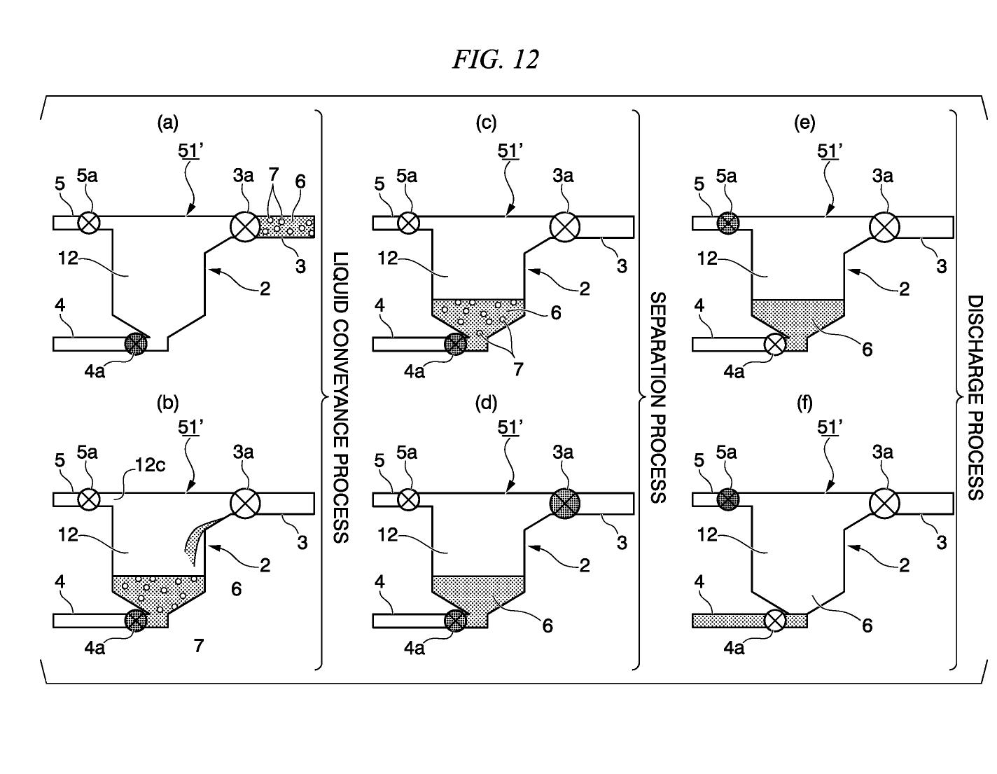

The separation method of the embodiment will be described with reference to FIG. 12. As an example, FIG. 12 shows a separation method using a variant of a separation apparatus designated by 51′ serving as the separation apparatus of the above-mentioned fifth embodiment.

The separation process may be a process of separating a gas from the liquid in the liquid storage structure, the liquid delivered into the liquid storage structure containing the gas serving as the substance. In the case in which the liquid contains the gas, in a fluid flowing through the flow path, the case in which bubbles are entrained in the liquid, the case in which a gas layer is disposed between the liquids, the case in which a gas is dissolved in the liquid such as carbonated water, or the like, is exemplified.

The liquid delivery process is preferably performed in a state in which the discharge flow path valve is closed. Further, in the separation process, the state in which the discharge flow path valve is closed is continued for a predetermined time, and then, after the separation process, a discharge process of opening the discharge flow path valve and discharging the liquid stored in the liquid storage structure is preferably further carried out.

Alternatively, the separation method of the present embodiment is a method of separating a gas contained in a liquid stored in a liquid storage structure including an introduction flow path, a discharge flow path, a gas discharge flow path, a discharge flow path valve installed at the discharge flow path, and a gas discharge flow path valve installed at the gas discharge flow path, the method including:

a liquid delivery process of delivering the liquid from the introduction flow path into the liquid storage structure in a state in which the discharge flow path valve installed at the discharge flow path is closed and in a state in which the gas discharge flow path valve installed at the gas discharge flow path is opened, and

a separation process of separating the gas contained in the liquid in the state in which the discharge flow path valve is closed and in the state in which the gas discharge flow path valve is opened.

Hereinafter, the processes in the above-mentioned separation method will be described.

First, the liquid delivery process of the present embodiment will be described with reference to FIGS. 12(a) to 12(b).

In the separation method of the embodiment, the separation apparatus 51′ shown in FIG. 12(a), a liquid 6 delivered into the liquid storage structure 12 contains bubbles 7.

Next, as shown in FIG. 12(b), the liquid 6 is delivered into the liquid storage structure 12. In advance, the inside of the liquid storage structure has a pressure lower than that of the introduction flow path, the liquid naturally flows thereinto when the introduction flow path valve 3a is opened, and thus, the liquid may be delivered.

The liquid delivery process is preferably performed in a state in which the discharge flow path valve is closed. In the separation apparatus 51′ shown in FIG. 12(b), the discharge flow path valve 4a is closed. As the liquid delivery process is performed in a state in which the discharge flow path valve 4a is closed, discharge of the liquid 6 from the discharge flow path can be prevented in a state in which the liquid 6 stored in the liquid storage structure 12 contains the bubbles 7.

In addition, as shown in FIGS. 12(a) to 12(b), in addition to the introduction flow path valve 3a, the gas discharge flow path valve 5a is also preferably opened. As suction from the gas discharge flow path 5 is performed in a state in which the gas discharge flow path valve is opened, the liquid may be delivered into the liquid storage structure. A known suction pump may be used for the suction, and the suction pump may be connected such that suction is performed via the gas discharge flow path 5. Further, when a gas discharge valve is opened in the liquid delivery process and, particularly, when the gas in the liquid storage structure is suctioned, in addition to gravity, since a suction force by suction to suction the gas in the liquid storage structure via the gas discharge flow path also acts as a force to separate the gas contained in the liquid, separation of the gas can be more efficiently performed.

Hereinafter, the separation process of the present embodiment will be described with reference to FIGS. 12(c) to 12(d).

FIG. 12(c) shows an aspect of the separation apparatus 51′ after the liquid delivery is completed. The liquid 6 containing the bubbles 7 is stored in the liquid storage structure 12 of the separation apparatus 51′. Further, in the present embodiment, while the case in which the separation process is performed after the liquid delivery process is performed, the separation process may be performed simultaneously with or partially simultaneously with the liquid delivery process.

In the separation process of the present embodiment, the state in which the discharge flow path valve is closed may be continued for a predetermined time. In the separation apparatus 51′ shown in FIGS. 12(c) and 12(d), the discharge flow path valve 4a is closed and the gas discharge flow path valve 5a is opened. Since the state in which the discharge flow path valve 4a is closed is continued for a predetermined time, the bubbles 7 can be more reliably separated from the liquid 6. A time of continuing the state in which the discharge flow path valve 4a is closed can be appropriately determined in consideration of the kinds of liquid stored in the liquid storage structure and the substances separated from the liquid, and combinations thereof. As an example, the state in which the discharge flow path valve 4a is closed may be continued for about 1 to 5 seconds.

As the gas discharge flow path valve 5a is opened, the separated gas can be easily discharged from the gas discharge flow path 5a. In addition, as the introduction flow path valve 3a is closed, the separated gas can be prevented from intruding into the introduction flow path.

The separation method of the present embodiment may further have a discharge process of opening the discharge flow path valve and discharging the liquid stored in the liquid storage structure, after the above-mentioned separation process. Hereinafter, the discharge process of the present embodiment will be described with reference to FIGS. 12(e) to 12(f).

As shown in FIG. 12(e), the discharge flow path valve 4a of the separation apparatus 51′ is opened, and as shown in FIG. 12(f), the liquid 6 from which the bubbles 7 stored in the liquid storage structure 12 are completely separated is discharged through the discharge flow path 4. A state in which the gas discharge flow path valve 5a is closed and the gas discharge flow path valve is closed may be provided. As the gas discharge flow path valve is in the closed state, the substances that moved into the gas discharge flow path can be prevented from being introduced into the liquid storage structure again.

In addition, as the suction from the discharge flow path 4 is performed, the liquid may be discharged from the liquid storage structure 12. A known suction pump may be used for the suction or a suction pump configured to suction via the discharge flow path 4 may be connected. Further, in FIG. 12, a combination valve of the introduction flow path valve 3a and the discharge flow path valve 4a is in an open state. However, the liquid can also be discharged as a combination valve of the gas discharge flow path valve 5a and the discharge flow path valve 4a is in an open state. Further, the liquid can also be discharged as all of the introduction flow path valve 3a, the discharge flow path valve 4a and the gas discharge flow path valve 5a are in an open state.

As a result, the bubbles can be separated from the liquid 6 containing the bubbles 7, and the liquid 6 from which the bubbles 7 are completely separated can be obtained. According to the aspect of the present invention, the substances can be more reliably separated from the liquid without waste of the liquid.

### <<Mixing Method>>

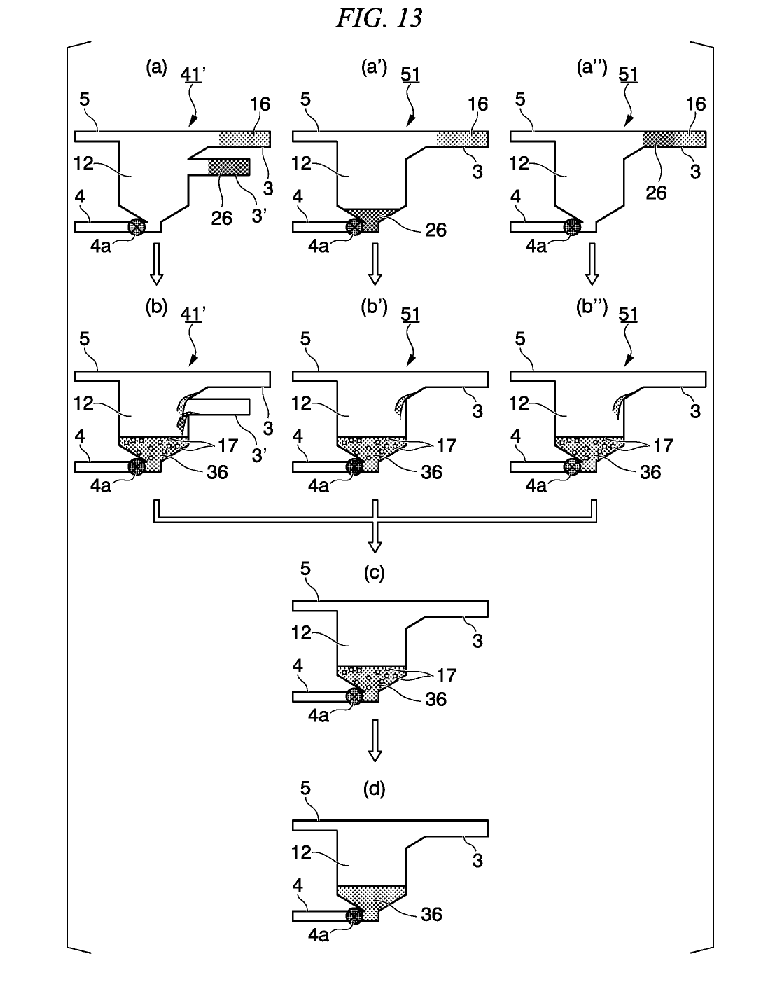

A mixing method of the embodiment is a method of mixing liquids in a liquid storage structure using the above-mentioned separation apparatus, the method including delivering a first liquid and/or a second liquid to a liquid storage structure through an introduction flow path and mixing the first liquid and the second liquid in the liquid storage structure. The mixing method of the present embodiment will be described with reference to FIG. 13.

In the separation apparatus shown in FIGS. 13(a) and 13(a′), an aspect of a first liquid 16 and a second liquid 26 before mixing is shown.

As shown in FIG. 13(a′), in the first liquid and the second liquid, the first liquid 16 may be delivered into the liquid storage structure 12 in which the second liquid 26 is stored through the introduction flow path 3. Alternatively, as shown in FIG. 13(a″), the first liquid 16 and the second liquid 26 may be sequentially delivered into the liquid storage structure 12 through the introduction flow path 3.

Alternatively, in the mixing method of the present embodiment, the first liquid through one introduction flow path and the second liquid through the other introduction flow path may be delivered into the liquid storage structure, and the first liquid and the second liquid may be mixed in the liquid storage structure. In the liquid delivery of the liquids, for example, as shown in FIG. 13(a), the first liquid 16 and the second liquid 26 are simultaneously delivered into the liquid storage structure 12 through the introduction flow path 3 and the introduction flow path 3′. The liquids can be introduced from a plurality of introduction flow paths to accomplish the mixing of the liquids for a short time, and further, introduction timing, introduction amounts, or the like, of the liquid can be easily controlled.

As the separation apparatus, the separation apparatus 41′ or the separation apparatus 51 including a plurality of introduction flow paths can be exemplified. The separation apparatus 41′ is a variant of the separation apparatus described in the fourth embodiment of the above-mentioned <<Separation apparatus>>. The separation apparatus 51 is the separation apparatus described in the fifth embodiment of the above-mentioned <<Separation apparatus>>. The first liquid 16 and the second liquid 26 introduced into the liquid storage structure are mixed with each other by turbulence generated upon liquid introduction.

Provisionally, when two liquids are mixed using a Y-shaped flow path without using the separation apparatus according to the present invention, the two liquids should be delivered at the same time. However, when the two liquids are mixed using the separation apparatus according to the present invention, timings of the liquid delivery may not be matched to each other. Further, when mixing rates of the two liquids are different, while a flow path length should be adjusted in the Y-shaped flow path, there is no need to adjust the flow path length in the liquid storage structure.

The substances contained in the liquid in the liquid storage structure may be separated from the liquids mixed in the liquid storage structure by the mixing method of the embodiment. In the separation apparatus 41′ or the separation apparatus 51 shown in FIGS. 13(b) to 13(b″), a third liquid 36 obtained by mixing the first liquid 16 and the second liquid 26 is stored in the liquid storage structure 12. As shown in FIG. 13(c), the third liquid 36 contains bubbles 17 generated by mixing of the first liquid 16 and the second liquid 26.

In the embodiment of the above-mentioned <<Separation method>>, the liquid 6 delivered into the liquid storage structure 12 is delivered in a state in which the bubbles 7 are already contained. However, as described in the mixing method of the embodiment, the substances separated in the liquid storage structure may not be introduced into the liquid storage structure 12 through the introduction flow path 3.

In the separation apparatus 51 shown in FIGS. 13(c) and 13(d), the discharge flow path valve 4a is closed. Since the state in which the discharge flow path valve 4a is closed is continued for a predetermined time, the bubbles 17 can be more reliably separated from the third liquid 36.

As a separate example of the case in which the substances contained in the liquid are separated in the liquid storage structure from the liquids mixed in the liquid storage structure, the liquid introduced into the liquid storage structure through the introduction flow path contains substances two or more substances, and the two or more substances contained in the liquid stored in the liquid storage structure may be separated.

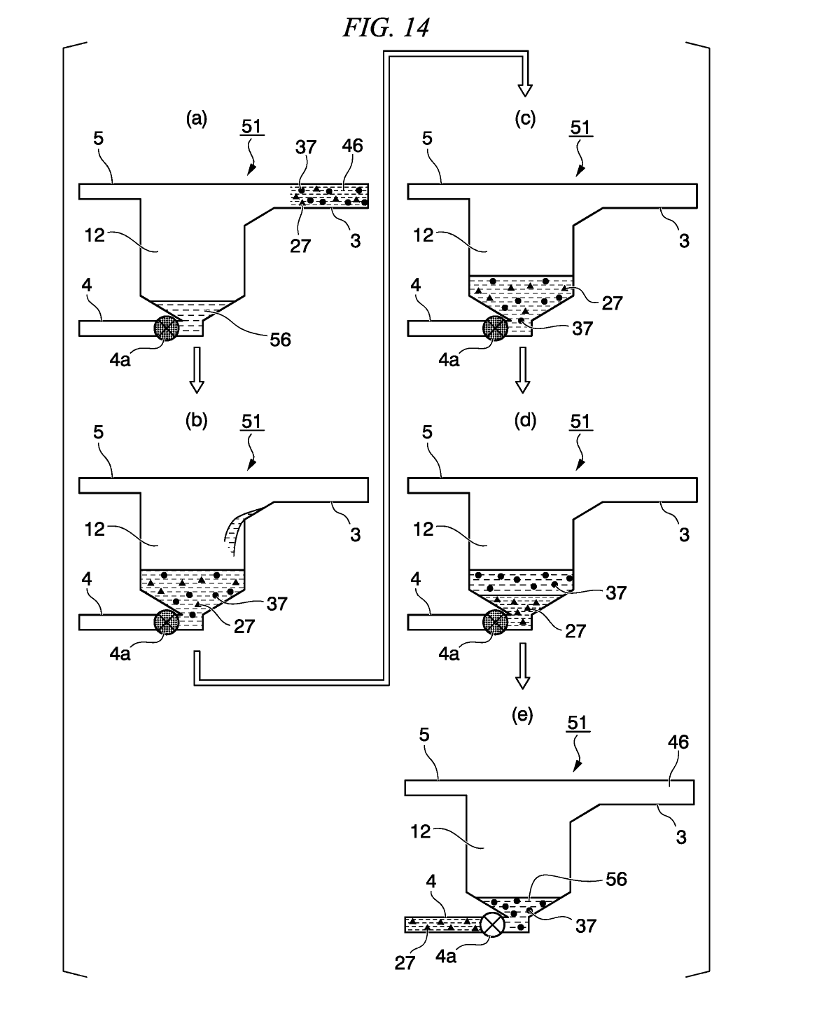

As shown in FIGS. 14(a) to 14(b), a fifth liquid 56 is previously stored in the liquid storage structure 12 of the separation apparatus 51, a fourth liquid 46 containing first particles 27 and second particles 37 is delivered into the liquid storage structure 12 through the introduction flow path 3, and the fourth liquid 46 and the fifth liquid 56 are mixed.

FIG. 14(c) shows a state in which the fourth liquid 46, the fifth liquid 56, the first particles 27 and the second particles 37 are mixed in the liquid storage structure 12.

Since the fourth liquid 46 and the fifth liquid 56 have different specific weights, the liquids are separated at upper and lower sides in the liquid storage structure 12, respectively. FIG. 14(d) shows a state in which the fifth liquid 56 is separated above and the fourth liquid 46 is separated below. In addition, the second particles 37 move toward the fifth liquid 56. This is because affinity of the second particles 37 with the fifth liquid 56 is higher than affinity with the fourth liquid 46. According to separation of the fourth liquid 46 and the fifth liquid 56, the first particles 27 and the second particles 37 can be separated.

Thereafter, the discharge flow path valve 4a is opened, and the fourth liquid 46 in which the second particles are separated from the liquid is discharged through the discharge flow path 4. As a result, the second particles 37 are separated from the fourth liquid 46 containing the first particles 27 and the second particles 37, and the fourth liquid 46 from which the second particles 37 are completely separated can be obtained.

Hereinafter, while the present invention will be described by the following examples, the present invention is not limited to the examples.

### EXAMPLES

### Example 1

### Separation of Bubbles

### Manufacture of Separation Apparatus and Fluid Device Including the Same

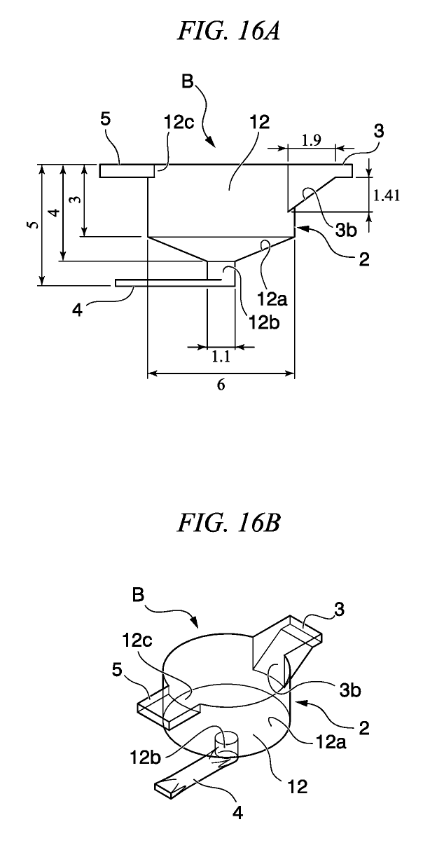

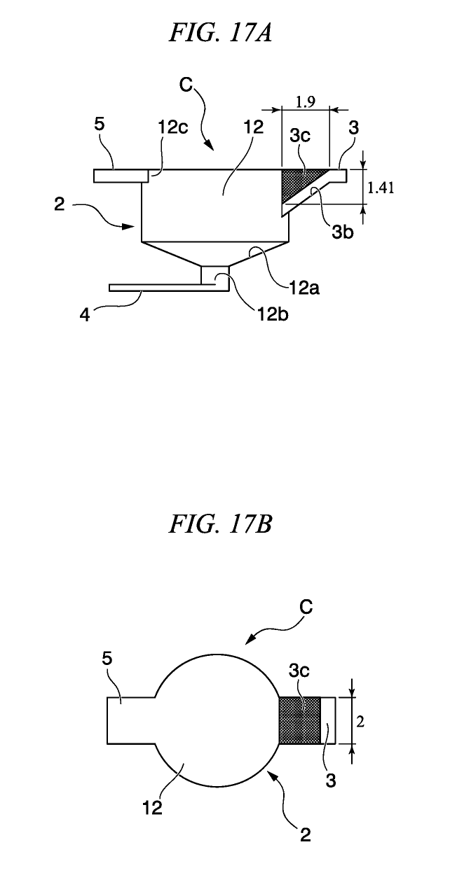

A plastic plate (Japan Acryace Corporation, Acryace MS) was cut to manufacture a separation apparatus A. FIGS. 15A and 15B are views showing a structure of the separation apparatus A. In addition to the configuration of the separation apparatus A, a separation apparatus B having an inclined section formed at an introduction flow path was manufactured. FIGS. 16A and 16B are views showing a structure of the separation apparatus B. Further, in addition to the configuration of the separation apparatus B, a separation apparatus C further having a prevention wall formed of polydimethylsiloxane (PDMS) and formed at the inner wall surface of the introduction flow path 3 was manufactured. FIGS. 17A and 17B are views showing a structure of the separation apparatus C. FIGS. 15A to 17B are shown in mm dimensions.

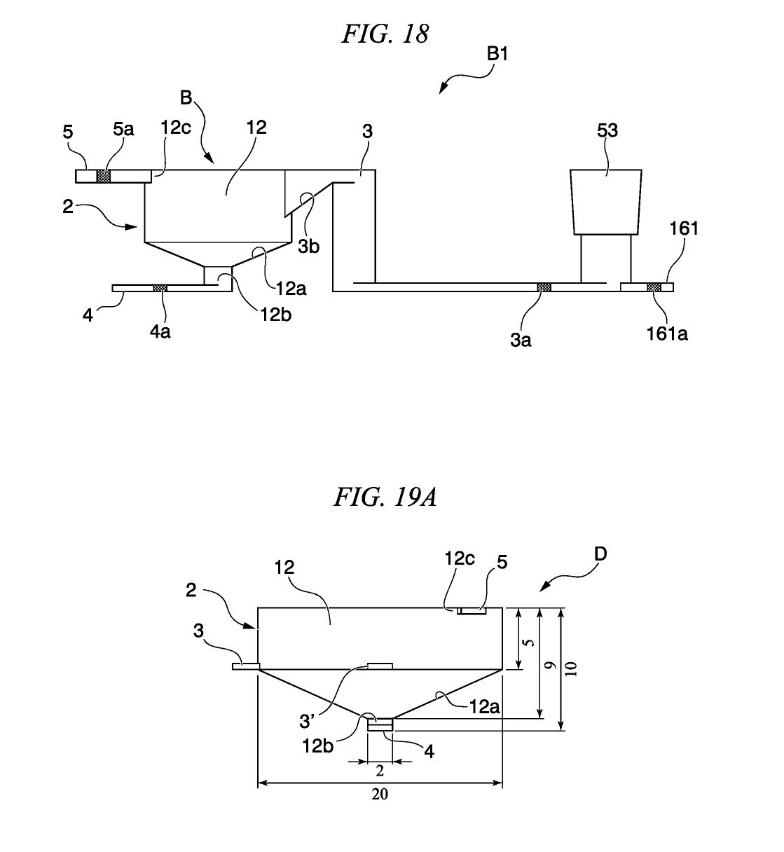

A plastic plate (Japan Acryace Corporation, Acryace MS) was cut to manufacture a fluid device A1 including the separation apparatus A and a biological molecule-refining unit. A silica membrane used for RNeasy Mini Spin Column attached to miRNeasy Mini Kit of QIAGEN Company was installed at the biological molecule-refining unit. In addition, similarly, a fluid device B1 including the separation apparatus B and the biological molecule-refining unit, and a fluid device C1 including the separation apparatus C and a biological molecule-refining unit were manufactured. As an example, FIG. 18 is a view showing a structure of the fluid device B1.

### [Verification Experiment]

A verification experiment was performed as follows using the fluid device A1, the fluid device B1 and the fluid device C1 manufactured as described above.

### (1) Nucleic Acid Captured by Silica Membrane

A nucleic acid was captured by passing a nucleic acid-capturing liquid through a silica membrane embedded in the biological molecule-refining unit. The nucleic acid-capturing liquid contains 1M guanidine thiocyanate serving as a chaotropic agent, 80% ethanol, and 100 amol miRNA serving as a biological molecule. The nucleic acid-capturing liquid of 1 ml was delivered at a suction pressure of 50 to 70 kPa, and the nucleic acid-capturing liquid was delivered to pass through a silica membrane for 1 minute. A valve 161a was opened, and the liquid passing through the membrane from a flow path 161 was discharged. Further, a valve 3a, a valve 4a and a valve 5a were closed (see FIG. 18).

### (2) Cleaning of Silica Membrane

Next, a cleaning liquid is introduced into the silica membrane to wash out guanidine thiocyanate.

The cleaning liquid is 80% ethanol, and a use amount thereof is 1 mL. The cleaning was performed by delivering the cleaning liquid at a suction pressure of 50 to 70 kPa for 1 minute. The valve 161a was opened, and the liquid passing through the membrane from the flow path 161 was discharged. Further, the valve 3a, the valve 4a and the valve 5a were closed.

### (3) Drying of Silica Membrane

In order to prevent drag-in of ethanol, the silica membrane was dried. The atmosphere was suctioned from the cleaning liquid introduction port to pass through the silica membrane to dry the silica membrane. The suction pressure was 50 to 70 kPa, and the time taken was 2 minutes. The valve 161a was opened, and the atmosphere was suctioned from the flow path 161. Further, the valve 3a, the valve 4a and the valve 5a were closed.

### (4) Elution of Nucleic Acid

A nucleic acid eluate was introduced into the membrane and a nucleic acid was eluted. The nucleic acid eluate was RNase-free water. A use amount of the nucleic acid eluate was 30 μl, and the eluate containing the nucleic acid was collected from the filter by suctioning the eluate at a suction pressure of 50 to 70 kPa for 10 seconds. The valve 3a and the valve 5a were opened, and the eluate was delivered into the introduction flow path 3 through suction from the gas discharge flow path 5. Further, the valve 4a and the valve 161a were closed. The nucleic acid eluate was eluted from the silica membrane while containing spray or bubbles.

(5) Introduction of Nucleic Acid Eluate into Separation Apparatus

Since the bubbles are separated from the nucleic acid eluate, the nucleic acid eluate was introduced into the separation apparatus.

The nucleic acid eluate was suctioned from the gas discharge flow path at a suction pressure of 10 to 50 kPa for 5 seconds, and the nucleic acid eluate was introduced into the liquid storage structure. The valve 3a and the valve 5a were opened, and the eluate was delivered into the liquid storage structure 12 through suction from the gas discharge flow path 5. Further, the valve 4a and the valve 161a were closed. Even when either of the fluid devices A1 to C1 was used, the liquid was stored in a lower portion of a space.

It was determined that a space capacity of the liquid storage structure is preferable to be sufficiently larger with respect to the eluate of 30 μL When the space capacity is 45 μL with respect to the eluate of 30 μL, there was a case in which the liquid was discharged from the gas discharge port. When the space capacity is 100 μL, only the gas was discharged, and the liquid was stored in the lower portion of the space.

### (Fluid Device A1)

Even when the fluid device A1 was used, the liquid was stored in the lower portion of the space of the liquid storage structure, and efficient separation was accomplished. However, in the case in which the fluid device A1 was used, when the nucleic acid eluate was introduced into the separation apparatus A, some of the nucleic acid eluate might arrive at the gas discharge port along the ceiling surface of the liquid storage structure.

### (Fluid Device B1)

When the fluid device B1 was used, in comparison with the case in which the fluid device A1 was used, a frequency and an amount of the nucleic acid eluate that arrived at the gas discharge port along the ceiling surface of the liquid storage structure was suppressed to a low level. This is considered because, in the separation apparatus B1, an introduction position of the liquid was able to be disposed far from the ceiling surface of the liquid storage structure by forming the inclined section at the introduction flow path.

### (Fluid Device C1)

However, when it was necessary to suction the liquid at a higher suction pressure, there was a case in which it was difficult to prevent the liquid from flowing along the ceiling surface of the liquid storage structure by only the structure of the separation apparatus B. In addition, it was considered that, even when affinity of a device material with a composition of the introduced liquid is strong, the liquid may not be prevented from flowing along the ceiling surface of the liquid storage structure.

Even when the liquid is suctioned at a high suction pressure using the fluid device C1, a frequency and an amount of the nucleic acid eluate that arrives at the gas discharge port along the ceiling surface of liquid storage structure were suppressed to a low level. This is considered because, in the separation apparatus C, as a prevention wall having a shape in which a triangular prism is horizontally disposed on the ceiling surface is formed at the introduction flow path, an introduction position of the liquid could be disposed further away from the ceiling surface.

(6) Discharge of Nucleic Acid Eluate from Liquid Storage Structure

The nucleic acid eluate stored in the liquid storage structure and containing no gas was discharged from the discharge flow path by suction. The valve 3a and the valve 4a were opened, and the eluate was discharged by suction from the discharge flow path 4. Further, the valve 5a and the valve 161a were closed.

### (7) Checking of Collected Nucleic Acid Eluate

It was visually checked that no bubbles remained in the nucleic acid eluate collected through the above-mentioned method.

In addition, the collected amount of the nucleic acid eluate was 23 μl. It was confirmed that, even when the liquid storage structure was not installed, the collected amount of the eluate was 23 μl, and there was no loss of the liquid caused by addition of the structure.

This result shows that, when refining a nucleic acid in a fluid device using a silica membrane and application using a refined nucleic acid is continuously performed, mixing of bubbles with a liquid sample can be prevented.

### Example 2

### Mixing of Two Liquids

### Manufacturing of Separation Apparatus and Fluid Device Including the Same

A plastic plate (Japan Acryace Corporation, Acryace MS) was cut to manufacture a separation apparatus D. FIGS. 19A to 19C are views showing a structure of the separation apparatus D. As shown in FIGS. 19A to 19C, the separation apparatus D includes two introduction flow paths 3 and an introduction flow path 3′. FIGS. 19A to 19C are shown in mm dimensions.

Further, a plastic plate (Japan Acryace Corporation, Acryace MS) was cut to manufacture a fluid device D1 including the separation apparatus D.

### [Verification Experiment]

A verification experiment was performed as follows using the fluid device D1 described above.

### (Reagent)

Ultra pure water and 100% ethanol were used for the two kinds of liquids to be mixed. In order to easily determine the mixing, a pigment was added into the ultra pure water.

(1) Introduction of Ultra Pure Water into Liquid Storage Structure

Ultra pure water (0.5 mL) colored through one of the introduction flow paths was introduced into the liquid storage structure by suction. A suction pressure was 1 to 30 kPa and the time taken was 15 seconds. The valve 3a and the valve 5a were opened, and the ultra pure water was delivered by suction from the gas discharge flow path 5 into the liquid storage structure 12 from the introduction flow path 3. Further, a valve 3a′ and a valve 4a were closed (see FIGS. 19A to 19C).

(2) Introduction of Ethanol into Liquid Storage Structure

Ethanol (0.5 mL) was introduced into the liquid storage structure through the other introduction flow path by suction.

A suction pressure was 1 to 30 kPa, and the time taken was 15 seconds. The valve 3a′ and the valve 5a were opened, and the ethanol was delivered by suction from the gas discharge flow path 5 into the liquid storage structure 12 from the introduction flow path 3′. Further, the valve 3a and the valve 4a were closed.

### (3) Mixing of Two Liquids

In parallel with the introduction of ethanol, the mixing of two liquids was visually checked. Mixing by turbulence generated according to introduction of the ethanol was checked.

In addition, it was determined that a sufficient margin in capacity of the space, in particular, a sufficient height is preferable to be provided in order to accomplish the mixing. When a space of a height of 5 mm, a diameter of 20 mm and a capacity of about 1.1 mL was used, there was a case where the liquid was tensioned on a wall surface of the space by surface tension and a meniscus portion arrived at the gas discharge port to flow the liquid to the outside. When a space having a height of 10 mm, a diameter of 20 mm and a capacity of about 2 mL was used, it was able to more easily accommodate the liquid in a lower portion of the space.

### (4) Discharge of Mixed Solution

The mixed solution was discharged from the discharge flow path by suction. The valve 3a′ and the valve 4a were opened, and the mixed liquid was discharged from the discharge flow path 4 by suction from the discharge flow path 4. Further, the valve 3a and the valve 5a were closed.

According to the above, the time taken for mixing of two liquids of a total 1 mL was 30 seconds, and a necessary space was sufficiently a space of 5 mm×20 mm. In addition, driving of the liquid was entirely performed by the suction pump. This shows that mixing of two liquids of a milli order in a fluid device can be performed in a small space for a short time by suction only.

What is claimed is:

1. A separation apparatus that separates a substance contained in a liquid, the separation apparatus comprising:
a liquid storage part having a liquid storage structure;
a discharge flow path that is disposed at a bottom surface of the liquid storage structure and that discharges the liquid stored in the liquid storage structure;
a discharge flow path valve that is installed at the discharge flow path; and
an introduction flow path that introduces the liquid into the liquid storage part.

2. The separation apparatus according to claim 1, wherein an inclined surface is formed at a bottom surface of the liquid storage structure.

3. The separation apparatus according to claim 2, wherein a discharge port that discharges the liquid stored in the liquid storage structure toward the discharge flow path is formed at the bottom surface of the liquid storage structure, and the inclined surface is inclined downward toward the discharge port.

4. The separation apparatus according to claim 3, wherein the inclined surface has a continuous gradient from side surfaces of the liquid storage structure to the discharge port.

5. The separation apparatus according to claim 1, wherein the discharge flow path has a first flow path connected to the discharge port, and a second flow path connected to the first flow path and through which a fluid flows in a direction different from the first flow path, and
the discharge flow path valve is disposed at the first flow path.

6. The separation apparatus according to claim 1, wherein a flow path inner diameter of the introduction flow path is √2 times or larger than a flow path inner diameter of the discharge flow path.

7. The separation apparatus according to claim 1, wherein the liquid stored in the liquid storage structure contains a gas serving as the substance, and
the liquid storage structure comprises a gas discharge port that discharges the gas from the liquid storage structure.

8. The separation apparatus according to claim 7, comprising a gas discharge flow path connected to the gas discharge port; and
valves installed at each of the gas discharge flow path and the introduction flow path.

9. The separation apparatus according to claim 1, wherein a suction pump that introduces the liquid into the liquid storage part is connected to the gas discharge port.

10. The separation apparatus according to claim 2, wherein the discharge port formed at the bottom surface of the liquid storage structure is disposed at a central portion of the bottom surface, and the inclined surface of the liquid storage structure is inclined downward to be focused toward the discharge port.

11. The separation apparatus according to claim 1, wherein a communication port that connects the liquid storage structure and the introduction flow path is opened at the inner wall surface of the liquid storage structure, and at least a portion of the communication port is formed above in a height direction of a liquid surface of the liquid stored in the liquid storage structure.

12. The separation apparatus according to claim 7, wherein a communication port that connects the liquid storage structure and the introduction flow path is opened at the inner wall surface of the liquid storage structure, and at least a portion of the communication port is formed below in a height direction of a liquid surface of the gas discharge port.

13. The separation apparatus according to claim 1, wherein a communication port that connects the liquid storage structure and the introduction flow path is opened at the inner wall surface of the liquid storage structure, and a portion of at least the bottom surface of the introduction flow path has an inclined section inclined with respect to and in communication with side surfaces of the liquid storage structure.

14. The separation apparatus according to claim 1, wherein an inclined member that introduces liquid into the liquid storage structure is installed to be connected to the communication port that connects the liquid storage structure and the introduction flow path, and
the inclined member protrudes toward an inside of the liquid storage structure, and is connected to the communication port such that a portion of the inclined member connected to the communication port is disposed at the uppermost side.

15. The separation apparatus according to claim 1, wherein a prevention wall that prevents liquid introduced from the introduction flow path from being scattered or flowing along the inner wall surface of the liquid storage structure is formed at an inner wall surface of the introduction flow path.

16. The separation apparatus according to claim 1, wherein at least one surface of side surfaces or a bottom surface of the liquid storage structure has higher affinity with the liquid, which can be introduced into the liquid storage structure, than that of at least one surface of a ceiling surface of the liquid storage structure or the gas discharge flow path.

17. A fluid device comprising the separation apparatus according to claim 1.

18. A separation method of separating a gas contained in a liquid stored in a liquid storage structure comprising an introduction flow path, a discharge flow path, a gas discharge flow path, a discharge flow path valve installed at the discharge flow path, and a gas discharge flow path valve installed at the gas discharge flow path, the separation method comprising:
a liquid delivery process of delivering the liquid into the liquid storage structure from the introduction flow path in a state in which the discharge flow path valve is closed and the gas discharge flow path valve is open; and
a separation process of separating the gas contained in the liquid in a state in which the discharge flow path valve is closed and the gas discharge flow path valve is open.

19. The separation method according to claim 18, wherein the separation process comprises separating the gas contained in the liquid by suctioning the gas in the liquid storage structure via the gas discharge flow path.

20. The separation method according to claim 18, comprising a discharge process of opening the discharge flow path valve in a state in which the gas discharge flow path valve is closed and discharging the liquid stored in the liquid storage structure.
